(19) United States
(12) Patent Application Publication
(10) Pub. No.: US 2026/0084503 A1
(43) Pub. Date: Mar. 26, 2026

(54) VEHICLE SUNSHADE ATTACHMENT STRUCTURE

(71) Applicant: AISIN CORPORATION, Kariya (JP)

(72) Inventors: Micah S. Wedekind, Livonia, MI (US); Jacob C. Grimaldo, Westland, MI (US)

(73) Assignee: AISIN CORPORATION, Kariya (JP)

(21) Appl. No.: 18/894,553

(22) Filed: Sep. 24, 2024

(51) Int. Cl. B60J 7/00

(52) U.S. Cl. CPC B60J 7/0023

(57) ABSTRACT

A vehicle sunshade attachment structure facilitates incorporation of a sunshade into a sunroof assembly of a vehicle. The vehicle sunshade attachment structure includes a post incorporated into an attachment element structured to be movable with respect to a roof of a vehicle when the sunshade attachment structure is installed in the vehicle. The sunshade attachment structure also includes a hole formed in a sunshade to be incorporated into the sunroof assembly. The sunshade is attached to the attachment element by inserting the post through the hole. A tab of the sunshade is structured to be wrappable over at least a portion of the attachment element so that the sunshade attachment structure is not visible by an occupant seated in an occupant compartment of the vehicle when the sunshade is attached to the post and the sunshade attachment structure is installed in the vehicle.

### TECHNICAL FIELD

The subject matter described herein relates to a sunroof assembly for a vehicle and, more particularly, to a structure for attaching a sunshade of a sunroof assembly to a movable portion of the sunroof assembly to enable deployment and retraction of the sunshade.

### BACKGROUND

Various structures and methods of attaching a sunshade to a vehicle sunroof assembly may include adhesives, tape and/or mechanical fasteners. Such attachment structures and methods may increase the labor and material costs associated with attaching the sunshade. Also, in the final production version of the vehicle, such attachment structures may be exposed and visible to an occupant positioned in the vehicle occupant compartment. Adhesive and other sunshade attachment interfaces that are visible to an occupant in the vehicle occupant compartment may be unsightly and may detract from the overall perceived quality of the vehicle.

### SUMMARY

In one aspect of the embodiments described herein, a vehicle sunshade attachment structure is incorporated into a sunroof assembly of a vehicle. The vehicle sunshade attachment structure includes a post incorporated into an attachment element structured to be movable with respect to a roof of a vehicle when the sunshade attachment structure is installed in the vehicle. The sunshade attachment structure also includes a hole formed in a sunshade to be incorporated into the sunroof assembly. The sunshade is attached to the attachment element by inserting the post through the hole.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale. Also, similar elements in the same or different views may be labeled with similar reference characters.

FIG. 1 is a schematic perspective view of a sunroof assembly incorporating a vehicle sunshade attachment structure in accordance with an embodiment described herein.

FIG. 2 is a magnified portion of the schematic perspective view of FIG. 1, showing portions of a sunshade attached to a drive shoe using a vehicle sunshade attachment structure in accordance with an embodiment described herein.

FIG. 3 is a schematic plan view of a portion of a deployable edge of the sunshade of FIG. 2, showing a tab of the sunshade.

FIG. 4 is another schematic perspective view of the portion of the sunshade shown in FIG. 2.

FIG. 5 is a schematic cross-sectional side view of the sunshade attachment structure embodiment shown in FIGS. 1, 3, and 4.

FIG. 6 is a schematic perspective view of an underside of one side of the sunroof assembly when installed in the occupant compartment, taken from the perspective of an occupant in occupant compartment.

### DETAILED DESCRIPTION

Embodiments described herein relate to a vehicle sunshade attachment structure incorporated into a sunroof assembly of a vehicle. The vehicle sunshade attachment structure includes a post incorporated into an attachment element structured to be movable with respect to a roof of a vehicle when the sunshade attachment structure is installed in the vehicle. The sunshade attachment structure also includes a hole formed in a sunshade to be incorporated into the sunroof assembly. The sunshade is attached to the attachment element by inserting the post through the hole. A sunshade tab is structured to be wrappable over at least a portion of the attachment element so that the sunshade attachment structure is not visible by an occupant seated in an occupant compartment of the vehicle when the sunshade is attached to the post and the sunshade attachment structure is installed in the vehicle.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

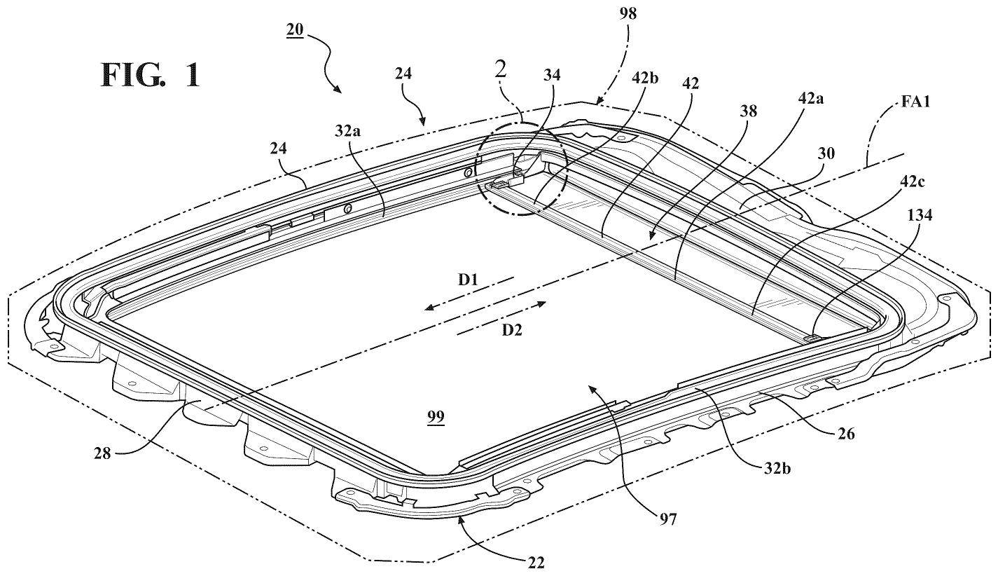

FIG. 1 is a schematic perspective view of a sunroof assembly 20 incorporating a vehicle sunshade attachment structure (generally designated 21) in accordance with an embodiment described herein. The sunroof assembly 20 is coupled to a roof 98 of a vehicle (not shown), for example, via one or more example fasteners and/or one or more example fastening methods or techniques. Further, the sunroof assembly 20 of FIG. 1 or at least part thereof is disposed in an aperture extending through the roof 98. The roof aperture can be, for example, a relatively large opening in the roof 98 that is sized and/or shaped to receive one or more sunroof assembly components.

The sunroof assembly 20 can include various elements. Some of the possible elements of the assembly 20 are shown in the drawings and will now be described. It will be understood that it is not necessary for the sunroof assembly 20 to have all of the elements shown in FIG. 1 or described herein. The sunroof assembly 20 can have any combination of the various elements shown in the drawings. Further, the sunroof assembly 20 can have additional elements to those shown in the drawings and described herein.

In one or more arrangements, the sunroof assembly 20 may include a frame 22 structured for attachment of other elements of the sunroof assembly thereto. The frame 22 may be fastened to the vehicle roof 98 within the vehicle roof aperture, to attach the sunroof assembly 20 to the vehicle. The frame 22 may include a first side 24, a second side 26 positioned opposite the first side 24, a front side 28, and a rear side 30. The first and second sides 24, 26 may extend parallel or substantially parallel with a fore-aft axis FA1 of the vehicle. The front side 28 and rear side 30 may reside along (and perpendicular to) the fore-aft axis FA1 of the vehicle. In the embodiment shown, the first side 24 is a right side of the frame 22 and the second side 26 is a left side of the frame 22 when the sunroof assembly 20 is installed in a vehicle in its end-use configuration. The various sides 24, 26, 28, 30 of the frame 22 may combine to define an opening 97 that leads from an exterior of the vehicle into an occupant compartment 99 of the vehicle when the sunroof assembly 20 is installed on the vehicle.

In one or more arrangements, to facilitate movement of a sunshade 38 of the sunroof assembly between the open and closed positions, the frame 22 may incorporate a pair of opposed sunshade guide tracks or rails 32a, 32b extending along the frame first and second sides 24, 26. More specifically, a first track 32a may extend along frame first side 24 and a second track 32b may extend along frame second side 26 opposite the first track 32a to provide paths or guideways along which movable sunshade components can travel.

As known in the pertinent field, the sunroof assembly 20 may be provided with a “sunroof” (e.g., a glass panel) (not shown) configured to be controllable to move in a known manner between an open position and a closed position. Movement of the sunroof to the open position exposes the vehicle occupant compartment 99 to the environment exterior of the occupant compartment 99. In the closed position, the opening 97 is physically blocked by the sunroof. To move the sunroof to the open position, the sunroof may be retracted into a cavity provided between a headliner of the vehicle and the roof 98.

Referring to FIG. 1, in some arrangements, the sunroof assembly 20 may also include a foldable sunroof shade (or “sunshade”) 38. the sunshade 38 may be configured to be controllable by a user to deploy and retract in a known manner between an open position (to uncover the opening 97 exposing the vehicle occupant compartment 99 to the exterior environment) and a closed position in which the sunshade 38 is interposed between the exterior environment and the occupant compartment 99. The closed sunshade 38 may also help reduce glare and the temperature of the occupant compartment 99, and may prevent damage to upholstery by blocking ultraviolet rays. The closed sunshade 38 may be translucent so as to allow a certain amount of visible light to enter the occupant compartment 99 through the sunshade 38. In some arrangements, the sunshade material is porous to permit a flow of air between the exterior environment and the occupant compartment 99.

In one or more arrangements, the sunshade 38 may be formed from a foldable material having suitable UV-absorbing properties and other properties. In particular arrangements, the sunshade 38 may be structured to be stowable on (and extendible from) a spring-loaded roller 40 connected to the frame 22. The sunshade 38 may be unwound from the roller 40 by operation of a suitable drive mechanism such as described herein. The sunshade 38 may be unwound from the roller 40 by an associated drive mechanism in direction D1 to its closed position. In some examples, the sunshade 38 is formed from a suitable polymer film (e.g., Mylar®) or a suitable fabric (e.g., a polyester mesh or weave).

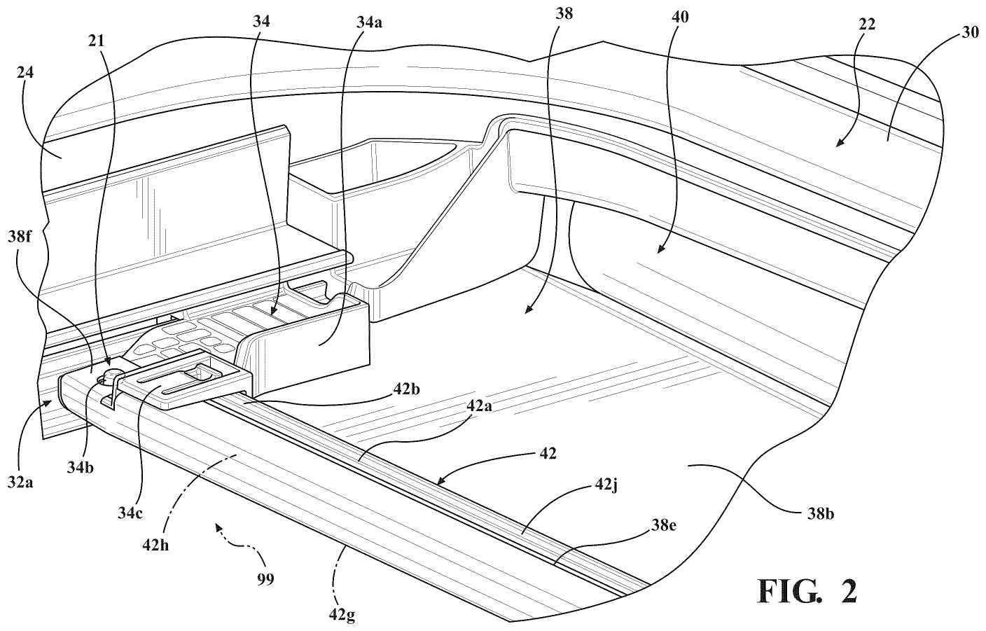

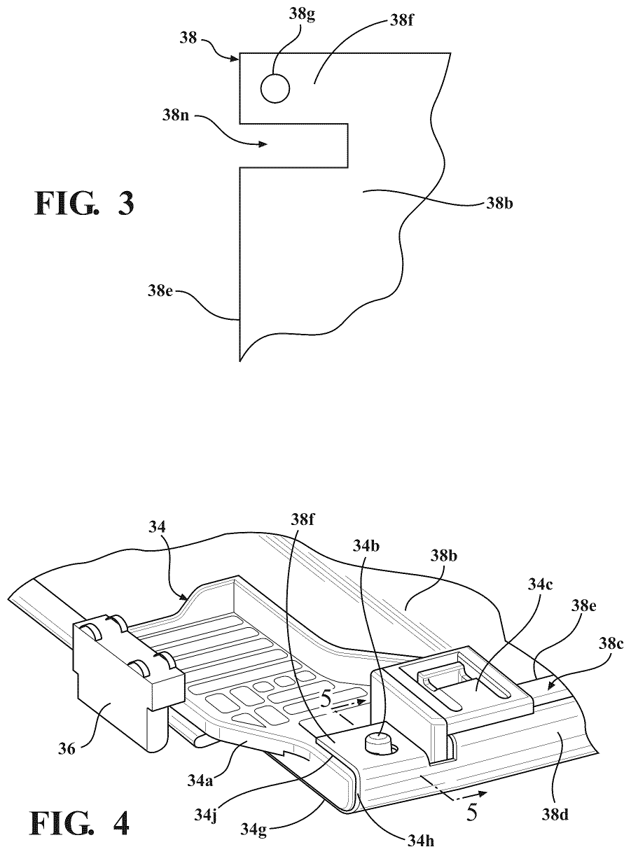

In one or more arrangements, the sunshade 38 may have a body portion 38b structured to be unwindable or deployable from the roller 40 to the closed position to cover the opening 97. The sunshade body portion 38b may also have a deployable edge 38e (an edge positioned opposite the end of the sunshade 38 wound around the roller 40 and structured to be movable along the opening 97 to open and close the opening 97). The sunshade 38 may also have one or more tabs 38f extending from the body portion 38b so as to be foldable separately from the body portion. FIG. 3 is a schematic plan view of a portion of a deployable edge of the sunshade of FIG. 2, showing a tab 38f of the sunshade. Although a single tab 38f is shown in the drawings for purposes of illustration, the sunshade 38 may include a pair of tabs 38f, with one tab extending from the body portion 38b adjacent each of the first and second sides 24, 26 of the frame 22, for attachment to a respective sunshade attachment element 34 (described in greater detail below) structured to be movable with respect to the vehicle roof 98 along a respective one of guide tracks 32a, 32b. Each tab 38f may have a hole 38g formed therein to enable attachment of the sunshade 38 to a respective sunshade attachment element 34. A notch 38n may be formed between the tab 38f and a portion of the sunshade body portion 38b including the deployable edge 38e.

As known in the pertinent art, to facilitate movement of the sunshade 38 between the open and closed positions, the sunroof assembly 20 may include (or be operatively connected to) one or more drive mechanisms (not shown). for example, in some arrangements, a suitable drive mechanism may include one or more motor(s) (not shown) and one or more cables, belts, chains, etc. (not shown) operatively connecting the motor(s) to a sunshade attachment element structured to be movable with respect to the vehicle roof 98 along a respective one of guide tracks 32a, 32b.

In some arrangements, the movable attachment element of the sunshade attachment structure may be in the form of a drive shoe 34 structured to be slidable or rollable along an associated one of sunshade guide tracks 32a, 32b. The arrangement of the drawings shows a pair of opposed drive shoes 34, 134. In some arrangements, a separate drive shoe including a post as described herein may be structured to be slidable or rollable along each of opposed sunshade guide tracks 32a, 32b. The cables, belts, chains, etc. may be connected and structured to transmit energy from the motor(s) to the drive shoes 34, 134 by generating tension in the cables, belts, chains, etc., to pull the drive shoes 34, 134 simultaneously along their respective guide tracks 32a, 32b in a first direction D1 and/or a second direction D2 extending parallel to the guide tracks. Referring to the drawings, in some arrangements, each drive shoe may be attached to an associated roller element 36 (FIG. 4) structured to facilitate smooth motion of the drive shoe with respect to the respective sunshade guide track.

Referring to the drawings, a drive shoe 34 in accordance with an embodiment described herein may include a body portion 34a and a post 34b extending from the body portion 34a. The body portion 34a may have an interior surface 34g, a forward edge 34h extending adjacent the interior surface 34g, and an exterior surface 34j extending adjacent the forward edge 34h. The interior surface 34g may be structured to face toward the occupant compartment 99 of the vehicle when the sunroof assembly 20 is installed in a vehicle in its end-use configuration. The forward edge 34h may be structured to face in a forward direction of the vehicle when the sunroof assembly 20 is installed in a vehicle in its end-use configuration. The exterior surface 34j may be structured to face in a direction away from the vehicle occupant compartment 99 when the sunroof assembly 20 is installed in a vehicle in its end-use configuration. In one or more arrangements, the post 34b extends from the body portion along the exterior surface.

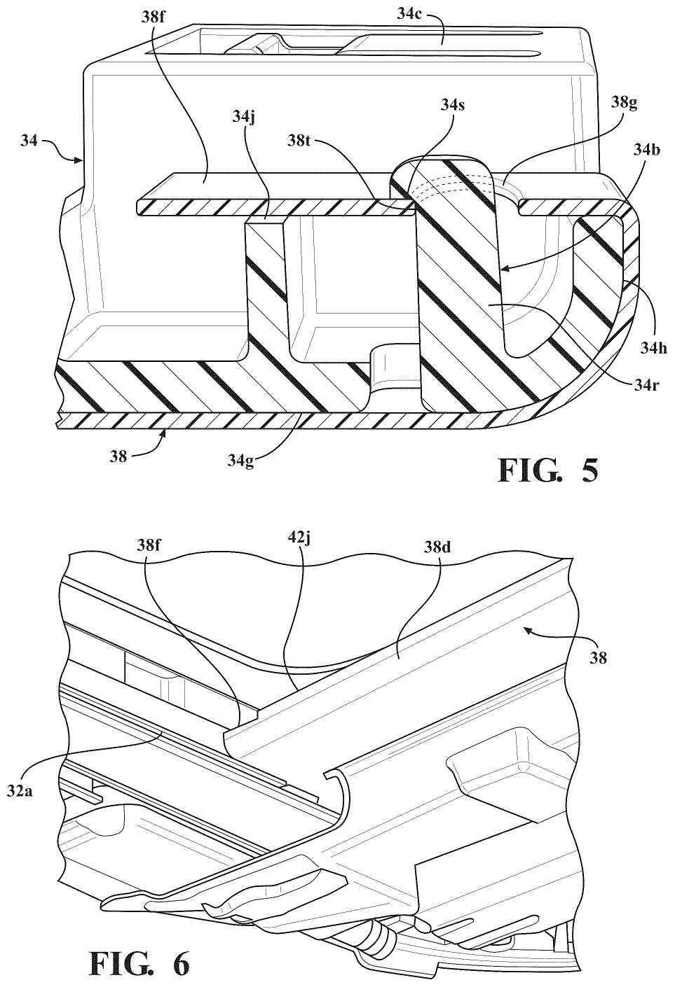

Referring to the drawings, in embodiments described herein, the vehicle sunshade attachment structure 21 may include a post as described herein incorporated into an attachment element (e.g., drive shoe 34). FIGS. 2 and 5 show post 34b extending from drive shoe body portion 34a. Referring in particular to FIG. 5, in some arrangements, the post 34b includes a base 34r and a shoulder 34s extending from the base 34r.

Referring to the drawings, a garnish 42 may extend between the attachment elements 34, 134 for attachment of a portion of the sunshade 38 thereto. The garnish 42 may include a body portion 42a, a first end 42b extending from the body portion 42a, and a second end 42c extending from the body portion 42a opposite the first end 42b. In the drawings, the garnish first end 42b is shown connected to the first drive shoe 34 and the garnish second end 42c is shown connected to the second drive shoe 134.

The garnish 42 may also have an interior surface 42g, a forward edge 42h extending adjacent the interior surface 42g and an exterior surface 42j extending adjacent the forward edge 42h. The garnish interior surface 42g may be structured to face toward the occupant compartment 99 of the vehicle when the sunroof assembly 20 is installed in a vehicle in its end-use configuration. The garnish forward edge 42h may be structured to face in the forward direction of the vehicle when the sunroof assembly 20 is installed in a vehicle in its end-use configuration. The garnish exterior surface 42j may be structured to face in a direction away from the vehicle occupant compartment 99 when the sunroof assembly 20 is installed in a vehicle in its end-use configuration.

In one or more arrangements, a portion of each drive shoe 34, 134 may be structured to cover or clamp an associated part of the sunshade body portion deployable edge 38e to the garnish 42. For example, FIG. 2 shows portion 34c of drive shoe 34 securing a portion of the deployable edge 38e to the garnish 42.

Referring to the drawings, the sunshade 38 may be attached to each of drive shoes 34, 134 by inserting the post of the respective drive shoe through a hole 38g in a respective tab 38f of the sunshade. For example, FIGS. 2 and 5 show post 34b inserted into tab hole 38g. The sunshade 38 may contact the post 34b along an edge 38t of the hole 38g such that detachment of the sunshade 38 from the post 34b is prevented by contact between the shoulder 34s and the edge 38t of the hole 38g.

attachment of the sunshade 38 to the movable attachment elements 34, 134 using the posts enables movement of the attachment elements in direction D1 (toward a front of the vehicle), which also correspondingly moves the attached garnish 42 and the deployable edge 38e of the sunshade 38 away from the sunshade roller 40 in direction D1 to partially or completely cover the opening 97. Conversely, movement of the attachment elements 34, 134 in direction D2 (toward a rear of the vehicle) enables takeup and retraction of the deployed sunshade 38 onto the spring-loaded roller 40.

FIG. 6 is a schematic perspective view of an underside of one side of the sunroof assembly 20 when installed in the occupant compartment 99, taken from the perspective of an occupant in occupant compartment 99. referring to the drawings, and in particular to FIG. 6, in one or more arrangements, the sunshade tab 38f, the sunshade attachment element (drive shoe) 34, and the post 34b may be structured and positioned so that the tab 38f is wrappable over at least a portion of the exterior surface 34j of the attachment element prior to attachment of the tab 38f to the post 34b as previously described, and so that the sunshade attachment structure 21 is not visible by an occupant seated in the vehicle occupant compartment 99 (i.e., from the perspective shown in FIG. 6) when the sunshade 38 is attached to the post 34b and the sunshade attachment structure 21 is installed in the vehicle. Also, in one or more arrangements, the sunshade tab 38f, the sunshade attachment element (drive shoe) 34, and the post 34b may be structured and positioned so that the tab 38f is wrappable over a portion of the attachment element 34 such that the portion of the attachment element over which the tab 38t is wrapped is not visible by an occupant seated in an occupant compartment of the vehicle when the sunshade 38 is attached to the post 34b and the sunshade attachment structure 21 is installed in the vehicle. In addition, in one or more arrangements, the garnish 42 and the sunshade 38 may be structured so that the portion of the sunshade 38 including the deployable edge 38e is wrappable over the garnish interior surface 42g, the garnish forward edge 42h, and at least a portion of the garnish exterior surface 42j so that the portion of the garnish over which the deployable edge 38e is wrapped is not visible by the occupant seated in the vehicle occupant compartment 99 when the portion of the sunshade including the deployable edge 38e is wrapped over the garnish 42.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6A, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A vehicle sunshade attachment structure comprising:
a post incorporated into an attachment element structured to be movable with respect to a roof of a vehicle when the sunshade attachment structure is installed in the vehicle; and
a hole formed in a sunshade,
wherein the sunshade is attached to the attachment element by inserting the post through the hole.

2. The vehicle sunshade attachment structure of claim 1, wherein the attachment element is a drive shoe operatively connected to a drive mechanism structured to move the sunshade from an open position to a closed position.

3. The vehicle sunshade attachment structure of claim 1, wherein the sunshade includes a foldable body portion and a tab extending from the body portion so as to be foldable separately from the body portion, and wherein the hole is formed in the tab.

4. The vehicle sunshade attachment structure of claim 3, wherein the tab and the attachment element are structured so that the tab is wrappable over a portion of the attachment element such that the sunshade attachment structure is not visible by an occupant seated in an occupant compartment of the vehicle when the sunshade is attached to the post and the sunshade attachment structure is installed in the vehicle.

5. The vehicle sunshade attachment structure of claim 3, wherein the tab and the attachment element are structured so that the tab is wrappable over a portion of the attachment element such that the portion of the attachment element over which the tab is wrapped is not visible by an occupant seated in an occupant compartment of the vehicle when the sunshade is attached to the post and the sunshade attachment structure is installed in the vehicle.

6. The vehicle sunshade attachment structure of claim 1, wherein the post includes a base and a shoulder extending from the base, and wherein the sunshade contacts the post along an edge of the hole such that detachment of the sunshade from the post is prevented by contact between the shoulder and the edge of the hole.

7. The vehicle sunshade attachment structure of claim 1, wherein a portion of the sunshade including a deployable edge of the sunshade is structured to be wrappable over a portion of a garnish so that the deployable edge of the sunshade is not visible by an occupant seated in an occupant compartment of the vehicle when the portion of the sunshade including the deployable edge is wrapped over the garnish.

8. The vehicle sunshade attachment structure of claim 1, wherein a portion of the sunshade including a deployable edge of the sunshade is structured to be wrappable over a portion of a garnish so that the portion of the garnish over which the deployable edge is wrapped is not visible by an occupant seated in an occupant compartment of the vehicle when the portion of the sunshade including the deployable edge is wrapped over the garnish.

9. A sunroof assembly including a sunshade attachment structure in accordance with claim 1.

10. A vehicle including a sunshade attachment structure in accordance with claim 1.
